(19) United States
(12) Patent Application Publication
(10) Pub. No.: US 2008/0231046 A1
(43) Pub. Date: Sep. 25, 2008

(54) Bellows-shaped hollow body

(75) Inventors: Miho Osaka, Aichi-ken (JP); Hiroyuki Mori, Aichi-ken (JP); Akira Suzuki, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 12/073,477

(22) Filed: Mar. 6, 2008

(30) Foreign Application Priority Data
Mar. 19, 2007 (JP) 2007-71429

(51) Int. Cl. F16L 27/108

(52) U.S. Cl. 285/145.5

(57) ABSTRACT

A bellows-shaped hollow body is provided with a bellows extending in a central axis direction thereof, and is made by blow molding. The bellows includes crests and roots, and has a constant height-wise dimension between the top of the crests and the bottom of the roots neighboring on the crests in a circumferential direction thereof. Moreover, the bellows further includes general sections and greater membrane-length sections in a circumferential direction thereof. In addition, the general sections exhibit a first membrane length that is a dimension from the bottom of one of the roots to the top of one of the crests neighboring on the one of the roots, and the greater membrane-length sections exhibit a second membrane length being greater than the first membrane length of the general sections.

The present invention is based on Japanese Patent Application No. 2007-71,429, filed on Mar. 19, 2007, the entire contents of which are incorporated herein by reference.

### BACKGROUND OF THE INVENTION

1. Field of the Invention The present invention relates to a bellows-shaped hollow body, which is made by blow molding method. A bellows-shaped hollow body can be used for automotive inlet duct, for instance.

2. Description of the Related Art

An inlet duct, which is disposed between an inlet and an air cleaner, comprises a bellows in order to absorb vibrations, or in order to improve the operability upon assembling. A hollow body, such as the inlet duct, has been usually manufactured using blow molding method. However, when manufacturing a hollow body comprising a bellows by blow molding method, the resulting hollow body might be provided with a bellows whose thickness differs variously from places to the other places locally because a parison turning into the bellows exhibits the rate of elongation which differs variously from places to the other places locally.

For example, it has been often the case that an inlet duct, for instance, is formed as an elliptical shape in cross section, or as an oval shape in cross section, in order to secure a space in the up/down direction, because it is necessary to dispose the inlet duct in a limited space such as engine room. When forming a bellows whose cross section is formed as such an oval or elliptical shape comprising minor-diameter sections and major-diameter sections by blow molding method, the major-diameter sections, which are disposed more away from the oval-shaped or ellipse-shaped cross section's central axis extending perpendicularly to a viewer, come to have a thinner thickness, but the minor-diameter sections, which are disposed nearer to the central axis, come to have a thicker thickness. Accordingly, the minor-diameter sections exhibit higher rigidity than the major-diameter sections do. Consequently, there might arise a problem that the resulting bellows has exhibited anisotropic bendability.

Moreover, even when a bellows has a perfect circle-shaped cross section, if a parison is placed horizontally within a mold and then is manufactured into a bellows by blow molding, the parison's lower side is less likely to elongate because it first contacts with the mold and is cooled accordingly. As a result, the parison's lower side comes to have a thicker thickness. Therefore, the resulting bellows has come to have an uneven thickness in the circumferential direction, and consequently might be associated with such a problem that the bendability has become anisotropic.

In view of the above, Japanese Unexamined Patent Publication (KOKAI) Gazette No. 2000-97,115 discloses that, in a hollow body comprising a bellows which is formed as an oval or elliptical shape in cross section, the height-wise dimension between the crests and roots of the bellows is made greater in parts extending in the minor-axis direction than in the other parts extending in the major-axis direction. That is, Japanese Unexamined Patent Publication (KOKAI) Gazette No. 2000-97,115 discloses that, in the cross section of the bellows, the minor-diameter sections have a greater height-wise dimension between the crests and roots than the major-diameter sections do.

However, in the conventional hollow body disclosed in Japanese Unexamined Patent Publication (KOKAI) Gazette No. 2007-97,115, the anisotropic bendability is made less by changing the height of the crests of the bellows or the depth of the roots of the bellows. Accordingly, the conventional hollow body has come to have an enlarged inside diameter or outside diameter. Consequently, when the conventional hollow body is applied to inlet duct, there might arise such fears that the resulting inlet duct exhibits an enlarged inlet resistance, and that it interferes with peripheral component parts being disposed around it.

### SUMMARY OF THE INVENTION

The present invention has been developed in view of the aforementioned circumstances. It is therefore an object of the present invention to provide a bellows-shaped hollow body, which comprises a bellows that not only has a constant height-wise dimension between the top of the crests and the bottom of the roots neighboring on the crests in the circumferential direction but also exhibits isotropic bendability without ever changing the outside diameter or inside diameter.

A bellows-shaped hollow body according to the present invention solves the aforementioned problems, is provided with a bellows extending in a central axis direction thereof, and is made by blow molding,
the bellows comprising crests and roots, and having a constant height-wise dimension between the top of the crests and the bottom of the roots neighboring on the crests in a circumferential direction thereof;

the bellows further comprising general sections and greater membrane-length sections in a circumferential direction thereof; and

the general sections exhibiting a first membrane length, the first membrane length being a dimension from the bottom of one of the roots to the top of one of the crests neighboring on the one of the roots, and the greater membrane-length sections exhibiting a second membrane length being larger than the first membrane length of the general sections.

In the present bellows-shaped hollow body, when the bellows has an oval or elliptical cross-sectional shape comprising minor-diameter sections and major-diameter sections, the minor-diameter sections can preferably be provided with the greater membrane-length sections. In this preferable modification of the present bellows-shaped hollow body, the top of the crests can preferably exhibit a first radius of curvature in the minor-diameter sections, and the top of the crests can preferably exhibit a second radius of curvature in the major-diameter sections: and the first radius of curvature can preferably be larger than the second radius of curvature, thereby providing the minor-diameter sections with the greater membrane-length sections. Moreover, the first radius of curvature of the top of the crests in the minor-diameter sections can preferably change from large to small gradually to the second radius of curvature of the top of the crests in the major-diameter sections in the direction away from the minor-diameter sections to the major-diameter sections.

In the above preferable modification of the present bellows-shaped hollow body, the top of the crests can preferably be formed as a planar shape in the minor-diameter sections, and the top of the crests can preferably be formed as a shape exhibiting a radius of curvature in the major-diameter sections, thereby providing the minor-diameter sections with the greater membrane-length sections. Moreover, the radius of curvature of the top of the crests in the minor-diameter sections can preferably change from infinitely large to small gradually to the radius of curvature of the top of the crests in the major-diameter sections in the direction away from the minor-diameter sections to the major-diameter sections.

In addition, parts of a parison that turns into the present bellows-shaped hollow body's bellows, parts which first contact with a mold, can preferably be provided with the greater membrane-length sections.

The bellows-shaped hollow body according to the present invention comprises the above-described bellows. The bellows comprises crests and roots, and has a constant height-wise dimension between the top of the crests and the bottom of the roots neighboring on the crests in a circumferential direction thereof. The bellows further comprises general sections, and greater membrane-length sections in a circumferential direction thereof. The general sections exhibit a first membrane length that is a dimension from the bottom of one of the roots to the top of one of the crests neighboring on the one of the roots. The greater membrane-length sections exhibit a second membrane length, which is greater than the first membrane length of the general sections. The bellows is provided with such greater membrane-length sections, which are disposed locally in a circumferential direction thereof. Moreover, the present bellows-shaped hollow body is made by blow molding. Accordingly, a parison, which turns into the greater membrane-length sections having a greater second membrane length, shows greater elongation. Consequently, the resulting greater membrane-length sections have a thinner thickness.

Let us herein imagine a case that a bellows has an oval-shaped or ellipse-shaped cross section, for instance. When making such a bellows by blow molding, the major-diameter sections of the bellows show greater elongation than the minor-diameter sections of the bellows do. As a result, the major-diameter sections have a thinner thickness, but the minor-diameter sections have a thicker thickness. Hence, when providing the minor-diameter sections with the above-described greater membrane-length sections according to the present invention that are likely to elongate, it is possible to make the thickness of the minor-diameter sections thinner, especially at the roots.

Thus, the bellows-shaped hollow body according to the present invention exhibits upgraded bendability at the minor-diameter sections. Therefore, the present bellows-shaped hollow body can demonstrate isotropic bendability in the circumferential direction of the bellows. Moreover, as described above, since the bellows has a constant height-wise dimension between the top of the crests and the bottom of the roots neighboring on the crests in the circumferential direction, the present bellows-shaped hollow body is free from such a problem that it exhibits enlarged in take resistance, or that it interferes with peripheral component parts.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is an explanatory diagram for illustrating an intake system, which uses an intake duct according to Example No. 1 of the present invention.

FIG. 2 is a perspective diagram for illustrating a major portion of the intake duct according to Example No. 1.

FIG. 3 is a cross-sectional diagram for illustrating a major portion of the intake duct according to Example No. 1 when it is cut with the “X” plane shown in FIG. 2.

FIG. 4 is another cross-sectional diagram for illustrating another major portion of the intake duct according to Example No. 1 when it is cut with the “Y” plane shown in FIG. 2.

FIG. 5 is an explanatory diagram in which a major portion of the intake duct according to Example No. 1 shown in FIG. 3 is enlarged.

FIG. 6 is another explanatory diagram in which another major portion of the intake duct according to Example No. 1 shown in FIG. 4 is enlarged.

FIG. 7 is a cross-sectional diagram for illustrating a major portion of a modified version of the intake duct according to Example No. 1, and is a diagram that corresponds to FIG. 4.

FIG. 8 is a cross-sectional diagram for illustrating an intake duct according to Example No. 2 of the present invention.

FIG. 9 is a diagram for illustrating a manufacturing method of the intake duct according to Example No. 2, and shows that a parison, which turns into the intake duct, is placed within a mold in a vertically cross-sectional view.

FIG. 10 is a diagram for illustrating the manufacturing method of the intake duct according to Example No. 2, and shows the parison, which turns into the intake duct, is placed within the mold in a horizontally cross-sectional view.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

A bellows-shaped hollow body according to the present invention is provided with a bellows extending in a central axis thereof, and is made by blow molding. The present bellows-shaped hollow body can be formed of material, such as soft resin. The soft resin can be thermoplastic elastomer, for instance.

The bellows comprises crests and roots, and exhibits a constant height-wise dimension between the top of the crests and the bottom of the roots neighboring on the crests in a circumferential direction thereof. Moreover, the bellows further comprises general sections and greater membrane-length sections in a circumferential direction thereof. Similarly to conventional bellows, the general sections of the bellows comprise crests being formed as a substantially triangular shape in cross) section, and roots being formed as a substantially inverted triangular shape in cross section. The general sections exhibit a first membrane length. Note herein that the term, “membrane length,” specifies a dimension from the bottom of one of the roots to the top of one of the crests neighboring on the one of the roots in the present specification. The greater membrane-length sections exhibit a second membrane length being greater than the first membrane length of the general sections. Accordingly, in the present specification, the term, “greater membrane-length sections,” specifies parts of the bellows whose membrane length is longer than that of the general sections. The greater membrane-length sections are present locally in the circumferential direction of the bellows. For example, the greater membrane-length sections can be formed in the following manner: by making a radius of curvature, exhibited by the top of the crests whose cross section is formed as a general triangle shape, greater than another radius of curvature, exhibited by the top of the general sections' crests; or by forming the top of the crests as a planar shape in the greater membrane-length sections.

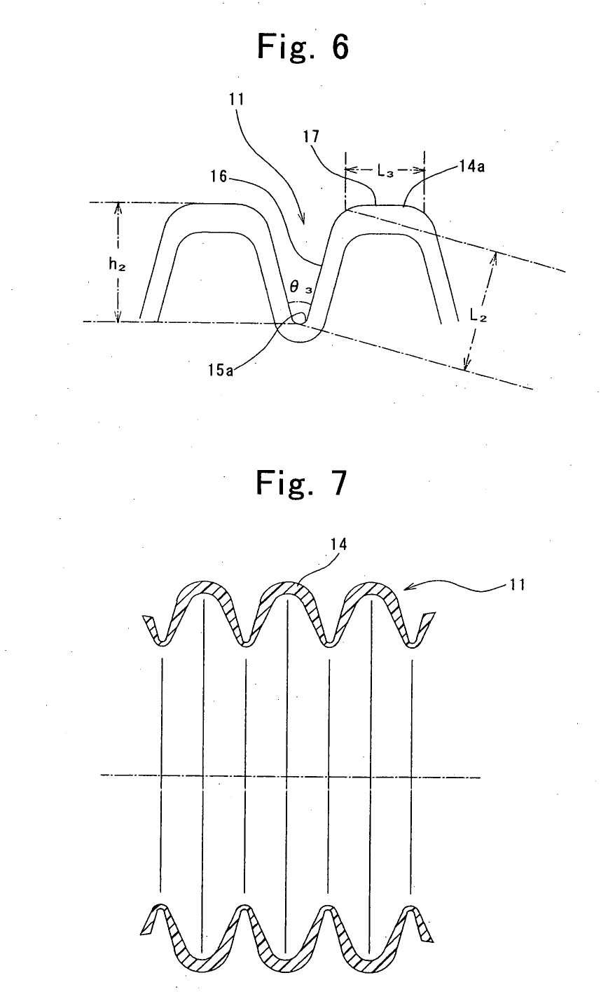

As described above, the bellows exhibits a constant height-wise dimension between the top of the crests and the bottom of the roots neighboring on the crests in the circumferential direction. Specifically, as later described in examples of the bellows-shaped hollow body according to the present invention, a height h₁ of the major-diameter sections' crests shown in FIG. 5 is equal to a height h₂ of the minor-diameter sections' crests shown in FIG. 6. Accordingly, when applying the present bellows-shaped hollow body to intake duct, the resulting intake duct hardly has an outside diameter or inside diameter, which is enlarged more than that of conventional inlet duct. Consequently, the resultant intake duct scarcely causes such a problem that it exhibits enlarged intake resistance, or that it interferes with peripheral component parts.

A cross section of the bellows can be formed as an oval shape or an elliptical shape, which comprises minor-diameter sections and major-diameter sections. In such a cross-sectionally oval or elliptical shape, the minor-axis-wise segments, which are disposed nearer to the oval-shaped or ellipse-shaped cross section's central axis extending perpendicularly to a viewer, make the minor-diameter sections; and the major-axis-wise segments, which are disposed more away from the central axis, make the major-diameter sections. The bellows of the bellows-shaped hollow body according to the present invention comprises the major-diameter sections, which are provided with the general sections, and the minor-diameter sections, which are provided with the greater membrane-length sections.

The bellows of the present bellows-shaped hollow body can preferably comprise the crests whose top exhibits a radius of curvature changing gradually from small to large in the direction away from the major-diameter sections to the minor-diameter sections. When the crests' top exhibits a radius of curvature changing rapidly, stress acts concentratedly on the segments of the resulting bellows at which the radius of curvature changes rapidly, and thereby the resultant bellows suffers from such a problem that it exhibits deteriorated vibrational characteristic, or that it is likely to break.

Moreover, of parts of a parison that turns into the bellows, a part, which first contacts with a mold, can be provided with the greater membrane-length sections. In this instance, the bellows can even be formed as a perfect circular shape in cross section. For example, when placing a parison horizontally within a mold and then molding the bellows by blow molding, the lower part of the parison, which contacts first with the mold, is cooled to exhibit heightened viscosity. Since the part, which exhibits higher viscosity, is less likely to elongate upon blow molding, the resulting bellows generally has come to have a thicker thickness at the part.

In view of the foregoing fact, of parts of the bellows, a part that is molded with a lower mold, can preferably be provided with the greater membrane-length sections; especially, the greater membrane-length sections can preferably be molded with a cavity surface of the lower mold, cavity surface which contacts first with a parison that turns into the bellows. Since the cavity surface, which molds the greater membrane-length sections, has a greater unit-length area than that of the other cavity surface, the parison's lower part is extended more than the parison's upper part is extended. Accordingly, it is possible to make the thickness of the molded greater membrane-length sections' root thinner. Consequently, the thus molded bellows exhibits isotropic bendability in the circumferential direction.

Note that the membrane-length difference between the greater membrane-length sections and the general sections in the bellows can be determined suitably depending on the expanding magnitude of parison, the thickness of individual bellows-shaped hollow bodies, and the resinous species. Note however that the minor-diameter sections' membrane length can preferably be greater than the general sections' membrane length by a factor of from 1.1 to 1.6.

### EXAMPLES

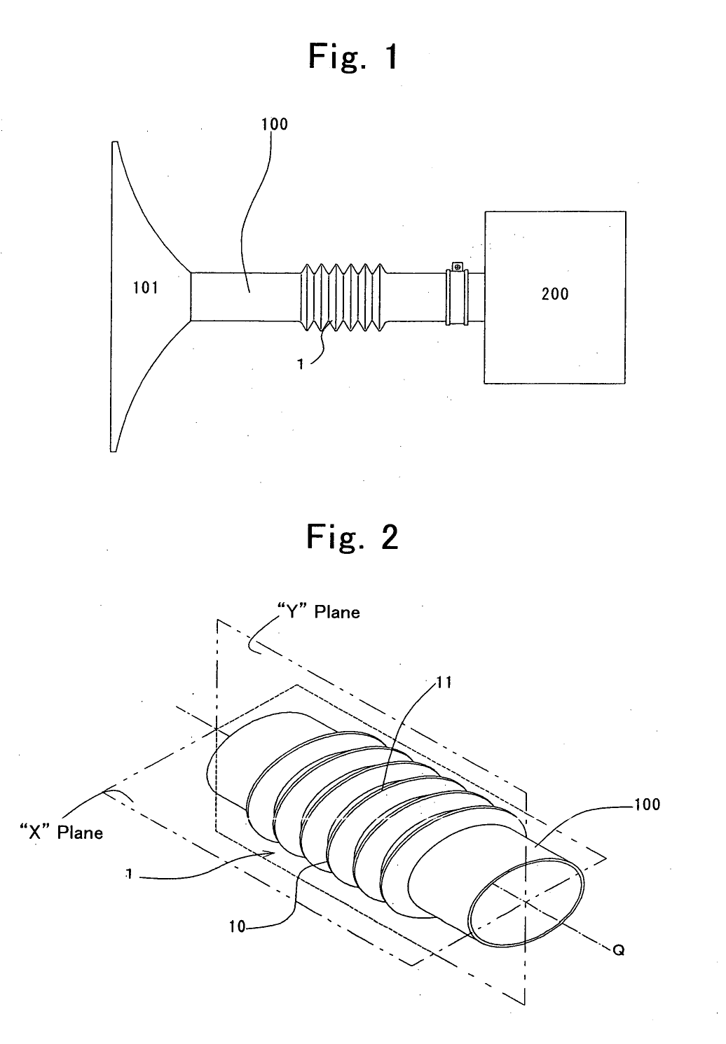

A bellows-shaped hollow body according to the present invention will be hereinafter described with reference to specific examples. In the following examples, the present bellow-shaped hollow body is applied to an inlet duct 100 shown in FIG. 1. As illustrated in the drawing, the inlet duct 100 comprises an inlet 101. The inlet 101 is disposed integrally at one of the opposite ends of the inlet duct 100. The inlet duct 100 is connected to an air clear 200 at the other one of the opposite ends. Moreover, the inlet duct 100 is provided with a bellows 1 for absorbing vibrations and for making the handling easier upon assembling.

### Example No. 1

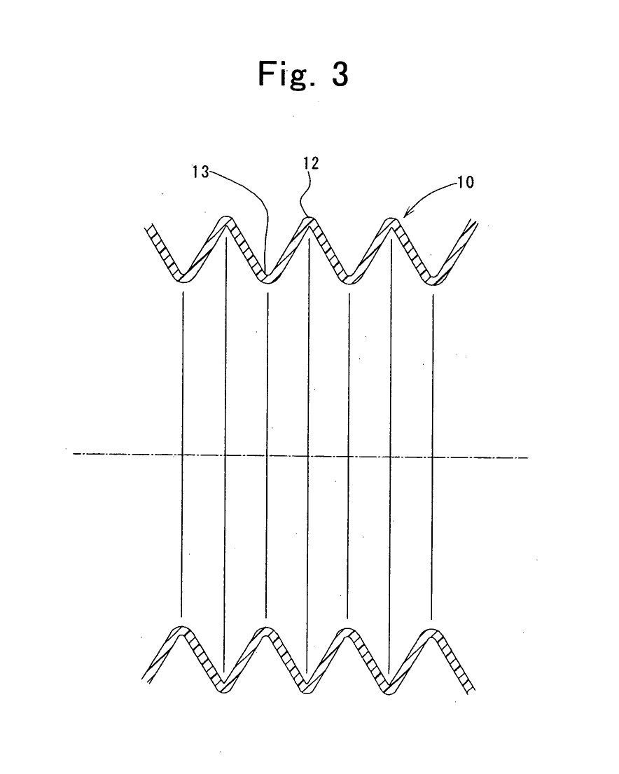

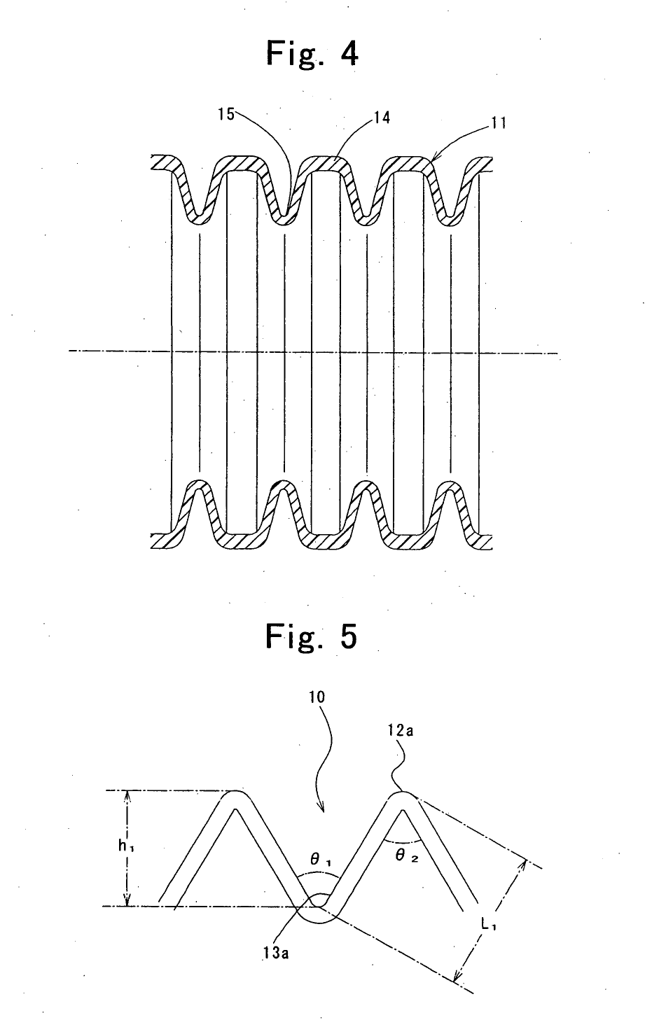

FIG. 2 illustrates the bellows 1 in a perspective view. FIGS. 3 and 4 illustrate the bellows 1 in cross-sectional views, respectively. As shown in the drawings, the bellows 1 is formed as an elliptical shape in cross section, and comprises major-diameter sections 10 and minor-diameter sections 11. The major-diameter sections 10 are disposed at around the major-axis-wise segments, which are disposed more away from the ellipse-shaped cross section's central axis “Q.” On the other hand, the minor-diameter sections 11 are disposed at around the minor-axis-wise segments, which are disposed nearer to the ellipse-shaped cross section's central axis

FIG. 3 is a cross-sectional diagram of the bellows 1, which is cut with the “X” plane designated in FIG. 1. FIG. 4 is another cross-sectional diagram of the bellows 1, which is cut with the “Y” plane that is disposed perpendicularly to the plane “X” as designated in FIG. 1. As illustrated in FIG. 3, the major-diameter sections 10 comprise a cross-sectionally triangular crest 12, and a cross-sectionally inverted triangular root 13, respectively. As illustrated in FIG. 5, an enlarged view of FIG. 3, the root 13 makes an angle θ₁, and the crest 12 makes θ₂ that is equal to θ₁ (i.e., θ₁=θ₂). A surface, which comes from the bottom of the root 13a, one of the roots 13, and which arrives at the top of the crest 12a, one of the crests 12, can be regarded as a flat surface substantially, and has a first membrane length that is equivalent to the dimension “L₁” designated in FIG. 5.

On the other hand, as illustrated in FIG. 4, the minor-diameter sections 11 comprise a crest 14 whose top is formed as a flat 17, and a cross-sectionally inverted triangular root 15, respectively. As illustrated in FIG. 6, an enlarged view of FIG. 4, the root 15 makes an angle θ₃, which is smaller than the angle θ₁ of the roots 13 in the major-diameter sections 10 (i.e., θ₃<θ₁). Note that a flat surface 16 rises from the bottom of the root 15a, one of the crests 15, at a more acute angle than the angle θ₁ of the roots 13 in the major-diameter sections 10. Moreover, the flat surface 16 extends from the bottom of the root 15a, and continues to the flat 17 in the crest 14a, one of the crests 14, neighboring on the root 15a. Accordingly, a surface, which comes from the bottom of the root 15a, and which arrives at the top of the crest 14a, has a second membrane length that is a sum of the flat surface 16's dimension “L₂” and a half of the flat 17's dimension “L₃” (i.e., “L₂”+“L₃”/2). Consequently, the second membrane length, “L₂”+“L_{3”}/2, in the minor-diameter sections 11 is longer than the first membrane length, “L₁,” in the major-diameter sections 10. That is, the major-diameter sections 10 make the general sections as claimed in the present specification, and the minor-diameter sections 11 make the greater membrane-length sections as claimed in the present specification.

Moreover, the crests 12 of the major-diameter sections 10 have a height “h₁” that is equal to a height “h₂” of the crests 14 of the minor-diameter sections 12 (i.e., “h₁”=“h₂”). That is, the bellows 1 exhibits a constant height-wise dimension between the top of the crests 12 or 14 and the bottom of the roots 13 or 15 neighboring on the crests 12 or 14 in the entire circumference. As a result, the bellows 1 hardly has an inside diameter or outside diameter, which has enlarged more than that of conventional bellows. Therefore, the bellows 1 little suffers from such a problem that it exhibits an enlarged inlet resistance, or that it interferes with peripheral component parts being disposed around it.

The inlet duct 100 according to Example No. 1 of the present invention is manufactured as follows: holding a cross-sectionally ellipse-shaped parison, which is extruded from above to down below, between paired right and left molds; and then carrying out blow molding by introducing compressed air into the parison. The paired right and left molds comprise major-diameter-section cavity surfaces, and minor-diameter-section cavity surfaces. The major-diameter-section cavity surfaces face the parts of the parison that turn into the major-diameter sections 10, and are formed as mold-symmetric surfaces that correspond to the crests 12 and roots 13. The minor-diameter-section cavity surfaces face the other parts of the parison that turn into the minor-diameter sections 11, and are formed as mold-symmetric surfaces that correspond to the crests 14 and roots 15.

The introduced compressed air expands the parison. Since the parts of the parison that expand to be pressed onto the major-diameter-section cavity surfaces are placed more away from the central axis of the ellipse-shaped cross section, they exhibit a greater elongation magnitude. Accordingly, the thus molded major-diameter sections 10 have a predetermined thickness. On the other hand, although the other parts of the parison that expand to be pressed on to the minor-diameter-section cavity surfaces are placed nearer to the central axis of the parison's ellipse-shaped cross section, they have the longer second membrane length (i.e., “L₂”+“L₃”/2). Consequently, the other parts of the parison also exhibit a greater elongation magnitude. Moreover, since the minor-diameter-section cavity surfaces are disposed nearer to the central axis of the parison's ellipse-shaped cross section, and since their mold-symmetric surfaces that correspond to the crests 14 of the minor-diameter sections 12 exhibit a longer dimension (i.e., “L₃” as designated in FIG. 6), the plasticized material that makes the parison is likely to flow onto the cavity surfaces that mold the crests 14 of the minor-diameter sections 11. As a result, although the thickness of the flats 17 is thicker than that of the roots 15, the thickness of the roots 15 in the minor-diameter sections 11 equal the thickness of the roots 13 in the major-diameter sections 10 substantially.

Therefore, the minor-diameter sections 11 exhibit bendability, which equals that of the major-diameter sections 10. Thus, the resulting inlet duct 100 comprises the bellows 1, which exhibits isotropic bendability in the circumferential direction.

Note that, in the inlet duct 100 according to Example No. 1 of the present invention, the crests 14 of the minor-diameter sections 11 are provided with the flat 17. However, as illustrated in FIG. 7, it is allowable as well to make a first radius of curvature, which the top of the crests 14 in the minor-diameter sections 11 exhibits, greater than a second radius of curvature, which the top of the crests 12 in the major-diameter sections 10 exhibits. In this way, it is also possible to make the minor-diameter sections 10 exhibit a longer second membrane length, “L₂”+“L₃”/2, which is greater the first membrane length “L₁” of the major-diameter sections 10. Hence, it is likewise possible to provide the inlet duct with a bellows whose circumferential bendability is isotropic.

### Example No. 2

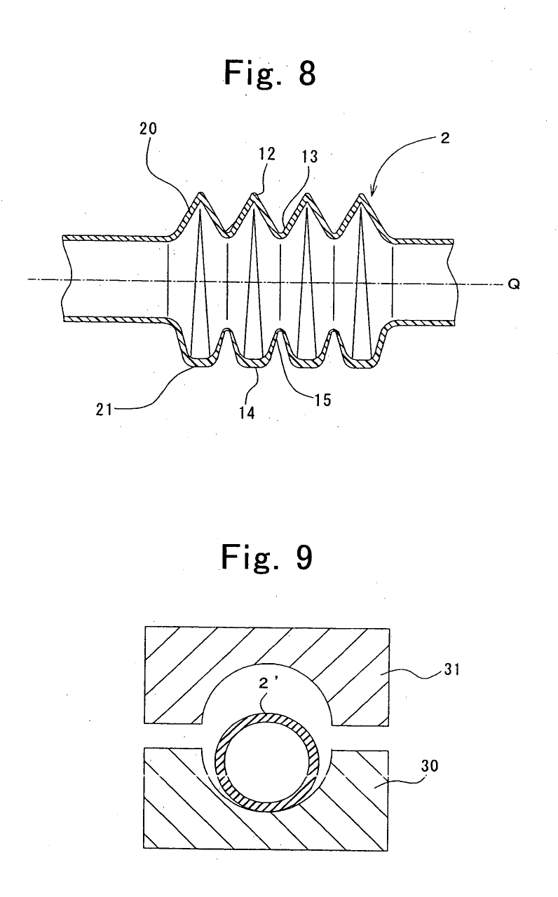

As illustrated in FIG. 8, an inlet duct according to Example No. 2 of the present invention comprises a bellows 2 whose cross section is formed as a perfect circular shape. The bellows 2 comprises general sections 20, and greater membrane-length sections 21. The general sections 20 are provided with a crest 12 and a root 13, respectively. The greater membrane-length sections 21 are provided with a crest 14 and a root 15, respectively. In one of the opposite circumferential parts of the bellows 2, the crests 12 and roots 13 are disposed alternately, and are formed as the same shapes as those of the bellows-shaped hollow body according to Example No. 1. In the other one of the opposite circumferential parts of the bellows 2 with respect to the central axis “Q,” the crests 14 and roots 15 are disposed alternately, and are formed as the same shapes as those of the bellows-shaped hollow body according to Example No. 1. The general sections 20 and greater membrane-length sections 21 are formed so as to exhibit equivalent bendability to each other. Moreover, the height-wise dimension between the top of the crests 12 or 14 and the bottom of the roots 13 or 15 neighboring on the crests 12 or 14 is constant in the entire circumference of the bellows 2.

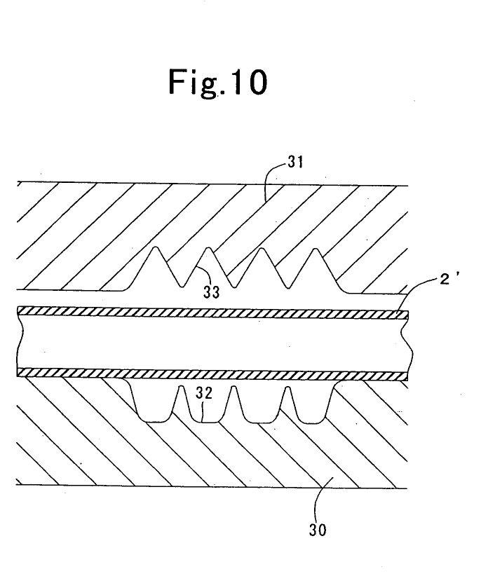

The inlet duct according to Example No. 2 of the present invention is manufactured as described below. First of all, as illustrated in FIG. 9 and FIG. 10, a cross-sectionally perfect-circle-shaped parison 2′ is placed on a lower mold 30's cavity surface, and is then held between the lower mold 30 and an upper mold 31. Thereafter, compressed air is introduced into the parison 2, thereby carrying out blow molding. Note that the lower mold 30 is provided with greater-membrane-length-section cavity surfaces 32, which are formed as mold-symmetric surfaces that correspond to the crests 14 and roots 15, at the lowermost part. Moreover, the upper mold 31 is provided with general-section cavity surfaces 33, which are formed as mold-symmetric surfaces that correspond to the crests 12 and roots 13, at the uppermost part. In addition, between the greater-membrane-length-section cavity surfaces 32 and the general-section cavity surfaces 33, intermediate cavity surfaces are formed so as to connect the greater-membrane-length-section cavity surfaces 32 to the general-section cavity surfaces 33, or vice versa, smoothly.

The parison 2′ first contacts with the lower mold 30's greater-membrane-length-section cavity surfaces 32. Accordingly, the lower parts of the parison 2′, which first contact with the lower mold 30's greater-membrane-length-section cavity surfaces 32, are cooled. Consequently, the lower parts of the parison 2′ exhibit a higher viscosity than the upper parts do. Therefore, upon blow molding, the lower parts of the parison 2′ are less likely to elongate than the upper parts are. However, the lower mold 30's greater-membrane-length-section cavity surfaces 32 have a greater unit-length area than the unit-length area of the upper mold 31's general-section cavity surfaces 33. Accordingly, the lower parts of the parison 2′ are elongated more than the upper parts are elongated. Consequently, the roots 15 of the greater membrane-length sections 21, which are molded by the lower mold 30, have a thinner thickness than the roots 13 of the general sections 20, which are molded by the upper mold 31, do. Therefore, the bellows 2 exhibits isotropic bendability in the circumferential direction.

On the contrary, in an inlet duct which is manufactured by the conventional manufacturing method, a bellows whose bendability is anisotropic has been produced, because, of the bellows, parts, which are molded by a lower mold's cavity surfaces, have a thicker thickness. Besides, the resulting bellows has a cross-sectionally perfect circular shape, it is difficult to find out and then pinpoint the parts, which have a thicker thickness, from the appearance of the resultant bellows. As a result, it is believed that an inlet duct, which is formed as a shape that does not exhibit any assembly orientation, might demonstrate degraded vibration damping ability.

On the other hand, the inlet duct according to Example No. 2 of the present invention comprises the bellows 2 whose bendability is isotropic in the circumferential direction. Hence, although the inlet duct according to Example No. 2 is processed into such a cylindrical shape that it is less likely to exhibit assembly orientation, it is free of the drawback that it demonstrates degraded vibration damping ability.

Having now fully described the present invention, it will be apparent to one of ordinary skill in the art that many changes and modifications can be made thereto without departing from the spirit or scope of the present invention as set forth herein including the appended claims.

What is claimed is:

1. A bellows-shaped hollow body being provided with a bellows extending in a central axis direction thereof, and being made by blow molding,
the bellows comprising crests and roots, and having a constant height-wise dimension between the top of the crests and the bottom of the roots neighboring on the crests in a circumferential direction thereof;
the bellows further comprising general sections and greater membrane-length sections in a circumferential direction thereof; and
the general sections exhibiting a first membrane length, the first membrane length being a dimension from the bottom of one of the roots to the top of one of the crests neighboring on the one of the roots, and the greater membrane-length sections exhibiting a second membrane length being larger than the first membrane length of the general sections.

2. The bellows-shaped hollow body according to in claim 1, wherein:
the bellows has an oval or elliptical cross-sectional shape comprising minor-diameter sections and major-diameter sections; and
the minor-diameter sections are provided with the greater membrane-length sections.

3. The bellows-shaped hollow body according to claim 2, wherein the top of the crests exhibits a first radius of curvature in the minor-diameter sections, and the top of the crests exhibits a second radius of curvature in the major-diameter sections: and
the first radius of curvature is larger than the second radius of curvature, thereby providing the minor-diameter sections with the greater membrane-length sections.

4. The bellows-shaped hollow body according to claim 3, wherein the first radius of curvature of the top of the crests in the minor-diameter sections changes from large to small gradually to the second radius of curvature of the top of the crests in the major-diameter sections in the direction away from the minor-diameter sections to the major-diameter sections.

5. The bellows-shaped hollow body according to claim 2, wherein the top of the crests is formed as a planar shape in the minor-diameter sections, and the top of the crests is formed as a shape exhibiting a radius of curvature in the major-diameter sections, thereby providing the minor-diameter sections with the greater membrane-length sections.

6. The bellows-shaped hollow body according to claim 5, wherein the radius of curvature of the top of the crests in the minor-diameter sections changes from infinitely large to small gradually to the radius of curvature of the top of the crests in the major-diameter sections in the direction away from the minor-diameter sections to the major-diameter sections.

7. The bellows-shaped hollow body according to claim 1, wherein parts of a parison that turns into the bellows, parts which first contact with a mold, are provided with the greater membrane-length sections.
